(19) United States
(12) Patent Application Publication
(10) Pub. No.: US 2013/0148898 A1
(43) Pub. Date: Jun. 13, 2013

(54) CLUSTERING OBJECTS DETECTED IN VIDEO

(71) Applicant: VIEWDLE INC., Los Angeles, CA (US)

(72) Inventors: Michael Jason Mitura, Carrollton, TX (US); Yuriy S. Musatenko, Kyiv (UA); Ivan Kovtun, Kyiv (UA); Denis Otchenashko, Kyiv (UA); Andrii Tsarov, Kiev (UA); Laurent Gil, San Francisco, CA (US)

(73) Assignee: VIEWDLE INC., Los Angeles, CA (US)

(21) Appl. No.: 13/706,371

(22) Filed: Dec. 6, 2012

Related U.S. Application Data
(60) Provisional application No. 61/569,168, filed on Dec. 9, 2011.

(51) Int. Cl. G06K 9/62

(52) U.S. Cl. CPC G06K 9/62
USPC 382/195

(57) ABSTRACT

Identification of facial images representing both animate and inanimate objects appearing in media, such as videos, may be performed using clustering. Clusters contain facial images representing the same or similar objects, providing a database for future automated facial image identification to be performed more quickly and easily. Clustering also allows videos or other media to be indexed so that segments that contain a certain object may be found without having to search through the entire length of the media. Clustering involves separating media data into individual frames and filtering for frames with facial images. A digital media processor may then process each facial image, compare it to other facial images, and form clusterizer tracks with the objective of forming a cluster. These newly formed clusters may be compared with previously formed clusters via key faces in order to determine the identity of facial images contained in the clusters.

### CROSS REFERENCE TO RELATED APPLICATIONS

This application claims the benefit of U.S. Provisional Application No. 61/569,168, filed Dec. 9, 2011, which is incorporated by reference herein in its entirety.

### FIELD OF ART

The disclosure relates generally to the field of video processing and more specifically to detecting, tracking and clustering objects appearing in video.

### BACKGROUND

Many media content consumers enjoy being able to browse through the media content such as images and video to find individuals or objects of their interest. Object and facial recognition techniques may be used by media content providers in order to properly detect and identify faces and objects.

However, some types of media, particularly video, have been difficult to apply recognition techniques to. Some of the difficulties relate to the computational complexity of measuring the differences between the video objects. Faces and objects in these video objects are often affected by factors such as differences in brightness, positioning and expression. An effective solution to facial and object recognition in videos would allow for a smoother browsing experience where a user may be able to search for segments in a video where a certain individual or object appears.

### BRIEF DESCRIPTION OF THE DRAWINGS

FIG. 1 is a block diagram illustrating a system environment for object detection and recognition and database population of objects for video indexing, in accordance with an embodiment.

FIG. 2 is a block diagram showing various components of a media processing system, in accordance with an embodiment.

FIG. 3A is a block diagram of an environment within which a facial image clustering module is implemented, in accordance with an embodiment.

FIG. 3B is a block diagram showing data flow and correlations between various components of a media processing system for implementing clustering, in accordance with an embodiment.

FIG. 4 is a block diagram showing various components of a facial image extraction module, in accordance with an embodiment.

FIG. 5 is a flow chart of a method for video processing involving facial image extraction and initial clustering, in accordance with an embodiment.

FIG. 6 illustrates a clusterizer track, in accordance with an embodiment.

FIG. 7 illustrates an example of merging clusters, in accordance with an embodiment.

FIG. 8 is a block diagram showing various components of a facial image clustering module, in accordance with an embodiment.

FIG. 9A is flow diagram illustrating a method for frame buffering, in accordance with an embodiment.

FIG. 9B is flow diagram illustrating a method for clusterized track processing, in accordance with an embodiment.

FIG. 9C is flow diagram illustrating a method for face quality evaluation, face collapsing, and cluster merging, in accordance with an embodiment.

FIG. 9D is flow diagram illustrating a method for facial image identity suggestion, in accordance with an embodiment.

FIG. 10 is a diagram representation of a computing device capable of performing the clustering of objects in media content.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

In one example embodiment, a system (and method) is configured for recognition and identification of objects in videos. The system is configured to accomplish this through clustering and identifying objects in videos. The type of objects may include cars, persons, animals, plants, etc., with identifiable features. Clusters can also be broken down further into more specific clusters that may identify different people, brands of cars, types of animals, etc. In an embodiment, each cluster contains images of a certain type of object, based on some common property within the cluster. Objects may be unique compared to other objects within an initial cluster, and thus can be furthered categorized or clustered according to their differences. For example, a specific person is unique compared to other people. While video objects containing any person may be clustered under a “people” identifier label, images containing a specific person may be identified by distinguishable features (e.g., face, shape, color, height, etc.) and clustered under a more specific identifier. However, there may be more than one cluster created per one person because a threshold level or other settings determine the creation of another cluster associated with the same individual. In an embodiment, further calculations may be performed to determine if facial images from the two clusters belong to the same person. Depending on the results, the clusters may be merged or kept separate.

Comparisons may be triaged such that less computationally expensive comparisons are performed and determinations (e.g., according to the degree of similarity between images) are made prior to performing more accurate or additional comparisons. For example, these initial comparisons may be used to determine whether or not two images are of the same person. A set of images determined to likely be of the same person may form an initial cluster. Within the initial cluster, further calculations may be used to determine an initial image to represent the clustered images or determine an identity of the cluster (e.g., the identity of the person). Furthermore, if images from two clusters are determined to be of the same person, then these two clusters may be merged to form a single cluster for the person.

The cluster data pertaining to the images may be stored in one or more databases and utilized to index objects and the videos in which they appear. In an embodiment where the object type for identification are people and the clustered objects are facial images of a person, the stored data may include, among other things, the name of the person associated with the facial images, the times or locations of appearances of the person in the video based on the determination of their facial image being present. In other embodiments, inanimate objects may also be considered for identification and clustering. For example, data stored for inanimate objects may include different types of cars. These cars may be clustered and identified through their different features such as headlights, rear, badge, etc., and associated with a specific model and/or brand.

The data stored to the database may be utilized to search video clips for specific objects by keywords (e.g., a specific person's name, brand or model of a car, etc.). The data stored in clusters provide users with a better video viewing experience. For example, clustering objects allows users searching for a specific person in videos to determine the video clips along with the times and locations in the clips where the searched person appears, and also to navigate through the videos by appearances of the object.

### Environment for Object Detection, Recognition, and Database Population

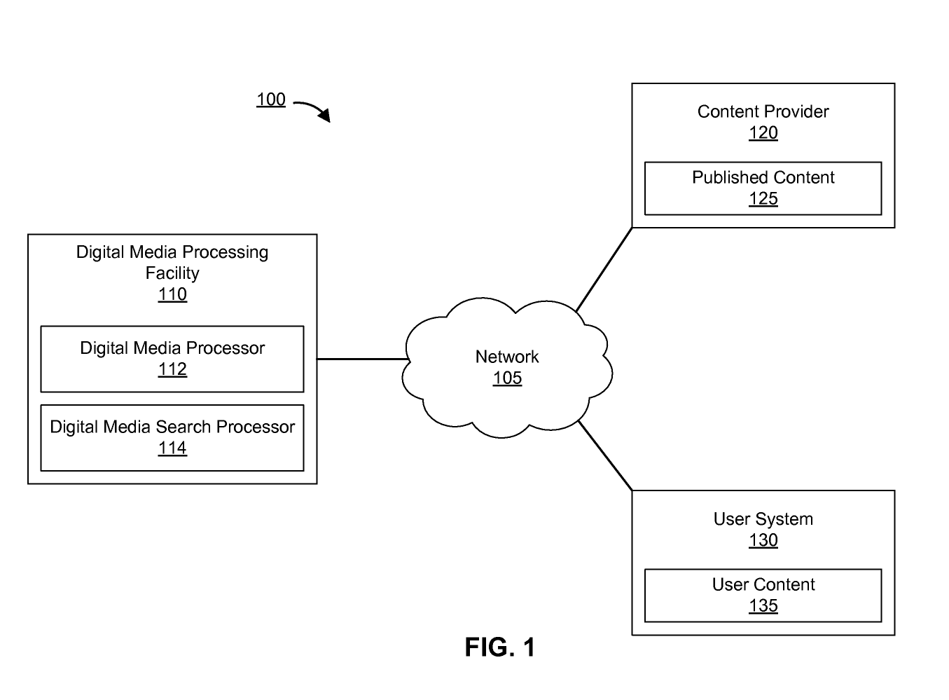

Turning now to FIG. 1, a block diagram illustrates a system environment for object detection and recognition and database population of objects for video indexing, in accordance with an example embodiment. As shown, the environment 100 may comprise a digital media processing facility 110, content provider 120, user system 130, and a network 105. Network 105 may comprise any combination of local area and/or wide area networks, mobile, or terrestrial communication systems that allows for the transmission of data between digital media processing facility 110, user system 130 and/or content provider 120.

The content provider 120 may comprise a store of published content 125. While only one content provider 120 is shown, there may be multiple content providers 120, each transmitting their own published content 125 over network 105. Published content 125 may include digital media content, such as digital videos or video clips, that content provider 120 owns or has rights to. Alternatively, the published content 125 may include user content 135 uploaded to the content provider 120 (e.g., via a video sharing service). As an example, the content provider may be a news service agency that provides news reports to digital media broadcasters (not shown) or otherwise provides access to the news reports (e.g., via a website or streaming service). The news reports, which may be in the form of videos or video clips, are the published contents 125 that are being distributed to other individuals or entities.

The user system 130 may comprise of a store of user content 135. There may be one or more user system 130 connected to network 105 in system environment 100. A user system 130 may be a general purpose computer, a television set (TV), a personal digital assistant (PDA), a mobile telephone, a wireless device, or any other device capable of visual presentation of data acquired, stored, or transmitted in various forms. Each user system 130 may store its own user content 135, which include media content stored on the user system 130. For example, any pictures, movies, documents, and so forth stored on a user's hard drive may be considered as user content 135. Furthermore, digital content stored in the “cloud” or a remote location may also be considered as user content 135.

Digital media processing facility 110 may further comprise a digital media processor 112 and a digital media search processor 114. In an embodiment, the digital media processing facility may represent fixed, mobile, or transportable structures, including any associated equipment, wiring, cabling, networks, and utilities, that provide housing to devices that have computing capability. Digital media from sources, such as published content 125 from content provider 120 or user content 135 from user system 130, may be sent over network 105 to digital media processing facility 110 for processing. The digital media processing facility may process received media content 125, 135 to detect, identify, cluster and index recognizable objects or individuals in the media content. Additionally, the digital media processing facility 110 may enable searching of the indexed objects or individuals in the media content.

Digital media search processor 114 may be any computing device (e.g., computer, laptop, mobile device, tablet and so forth) that is capable of performing a search through a store of digital contents. This may include searches through content available on network 105 for specific digital content or it may involve searches through content or indexes already present in digital media processing facility 110. For example, digital media processing facility 110 may receive a request to search for instances when a specific individual appears in some set of digital media content (e.g., videos). Digital media search processor 114 runs the search through content and indexes available to it before returning a list of results.

The digital media processor 112 may be, but is not limited to, a general purpose processor for user in a personal or server computer, laptop, mobile device, tablet, or some other type of processor capable of receiving, processing, and distributing digital media content. In an embodiment, the digital media processor 112 is capable of running processes on a digital media content store to detect, identify, cluster, and index objects that appear in the content store. This is only an example of what digital media processor 112 is capable of and other embodiments of digital media processor 112 may include more or less capabilities.

### Digital Media Processor Components

While the following description discusses various embodiments related to the identification of persons based on their facial images, it will be readily understood by one skilled in the art, as described previously, that the following examples can be applied to other animate and inanimate entities, such as a horse or a car. Thus, facial images may be used to refer to the facial fronts of both animate and inanimate objects. Furthermore, while the following description discusses digital media as videos and video clips, it will be readily understood by one skilled in the art that other embodiments of digital media, such as sequences of images, singular images, and other visual displays, may also be considered.

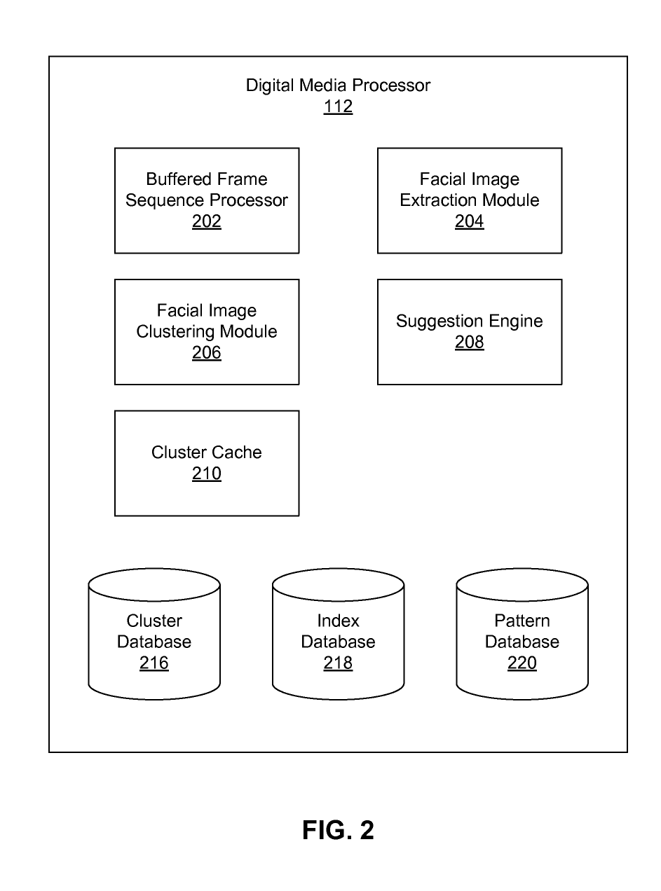

FIG. 2 is a block diagram showing various components of a media processing system, in accordance with an embodiment. In one embodiment, the digital media processor 112 comprises a buffered frame sequence processor 202, facial image extraction module 204, facial image clustering module 206, suggestion engine 208, cluster cache 210, cluster database 216, index database 218, and pattern database 220. Other embodiments of digital media processor 112 may include different or less modules.

The digital media processor 112 processes media content received at the digital media processing facility 110. As described previously, the media content may comprise moving images, such as video content. The video content may include a number of frames, which, in turn, are processed by digital media processor 112. The number of frames for a given length of video depends on the samples per seconds that the original recording was produced and the duration of time of the recording. For example, a video clip recorded at 30 frames per second and is 1 minute long will contain 1800 frames. In an embodiment, digital media processor 112 may immediately start processing the 1800 frames. However, in another embodiment, digital media processor 112 may store a given number of frames into a buffered frame sequence processor 202.

The buffered frame sequence processor 202, in an embodiment, may be configured to process media content received from a content provider 120 or user system 130. For example, buffered frame sequence processor 202 may receive a video or a video feed from content provider 120 and partition the video or segments of video received in the video feed into video clips of certain time durations or into video clips having a certain number of frames. These video clips or frames are stored in the buffer before it is sent to other modules.

In an embodiment, facial image extraction module 204 may receive processed digital content (i.e., video frames) from buffered frame sequence processor 202 and detect facial images or other types of objects present in the video frames. Detecting facial images within the video indicates the appearance of people in the video, with further processing possibly performed to determine the identity of the individual. However, some frames in the video may contain more than one facial image or no facial image at all. The facial image extraction module 204 may be configured to extract all facial images appearing in a single frame. Conversely, if a frame does not contain any facial images, the frame may be removed from the buffer and not considered during further extraction and identification processes. In some embodiments, frames proximate to other frames identified with specific facial images may still be associated with individual that had shown up in the facial image frames. For example, on THE DAILY SHOW with Jon Stewart, when Jon Stewart shows up on screen, talks for a few minutes, plays a video of President Obama, and then makes jokes about the video, the entire segment may be associated with Jon Stewart (despite him not appearing in all of the frames). Furthermore, the shorter segment with the video on Obama may also be associated with President Obama.

The facial image extraction module 204 may also be configured to perform other procedures within digital media processor 112. In an embodiment, the facial image extraction module 204 may also be configured to extract textual content of the video frames and save the textual content. Consequently, the textual content may be processed to extract text that suggests the identity of the person or object appearing in the media content. In some embodiments, the textual content may be used to identify the type of video that the video frames had originated from and also other people appearing in the same frame. For example, a clip with President Obama appearing on a news report may have frames labeled as “news” as well as “President Obama.” If President Obama appears on other shows such as THE TONIGHT SHOW with Jay Leno, those video frames may be labeled as “comedy show,” “President Obama,” and “Jay Leno.” If the facial image extraction module 204 is unable to identify the individual, it may prompt a user or operator to identify the person or object in the image.

In an embodiment, the facial image extraction module 206 may normalize the extracted facial images. Normalizing extracted facial images may include digitally modifying images to correct faces for factors that may include, but is not limited to, orientation, position, scale, light intensity, and color contrast. Normalizing the extracted facial images allows the facial image clustering module 206 to more effectively compare faces from an extracted image to faces in other extracted images or templates and, in turn, cluster the images (e.g., all images the same individual). Facial image comparisons allow facial image clustering module 206 to accurately cluster facial images of the same person together and to merge different clusters together if they contain facial images of the same individual. Additionally, the facial image clustering module 206 may identify the frame containing the facial image and optionally cluster the frame.

The suggestion engine 208, in an embodiment, may be configured to label the normalized facial images with suggested identities of a person associated with the facial images in the cluster (e.g., the facial images in the cluster are of the person). To label the clusters, the suggestion engine 208 may compare the normalized facial images to reference facial images, and based on the comparisons, may suggest one or more persons' identities for the cluster. Furthermore, suggestion engine 208 may use the textual context extracted by facial image clustering module 206 to determine identities for the faces present in each cluster.

In an embodiment, cluster cache 210 may be used by digital media processor 112 to temporarily store the clusters created by the facial image clustering module 206 until the clusters are labeled by the suggestion engine 208. Each cluster may be assigned a confidence level that is based in part on how well digital media processor's 112 determines a probable person's identity matches the facial images in the cluster. These confidence levels may be assigned by comparing normalized facial images in the cluster with clusters present in patterns database 220. In one embodiment, the identification of facial images is based on a distance calculation from a normalized input facial image to reference images in the patterns database 220. In an embodiment, distance calculations comprise of discrete cosine transforms. Other embodiments may use various other methods of calculating distances or variance between two images.

The clusters in the cluster cache 210 may be saved to cluster database 216 along with labels, face sizes, and corresponding video frames after the facial images in the clusters are identified. Cluster cache 210 may also be used to store representative facial images and corresponding information of people that appear often in video processed by digital media processor 112. For example, if the digital media processor 112 is processing video from a same source or television program, the cluster cache 210 may include clusters of individuals frequently identified (e.g., Bill O'Reilly on FOX) or recently identified (e.g., Bill O'Reilly's guest) in the video. Cluster cache information may also be used for automatic decision making as to which person the facial images of a cluster belongs to. Specifically, if Bill O'Reilly and his guest are the only individuals identified in a portion of a video, the cluster cache 210 may restrict comparisons to only the clusters representing Bill O'Reilly and his guest until another individual is identified in the video (e.g., comparisons do not identify the individual as either Bill O'Reilly or the guest). This allows the suggestion engine to more quickly identify individuals that appear repeatedly in a video.

The cluster database 216, in an embodiment, may be a database configured to store clusters of facial images and associated metadata extracted from received video. Once the clusters have been named in the cluster cache 210, they may be stored in a cluster database 216. The metadata associated with the facial images in the clusters may be updated when previously unknown facial images in the cluster are identified. The cluster metadata may also be updated manually by comparing the cluster images to known reference facial images. The index database 218, in an embodiment, may be a database populated with the indexed records of the identified facial images, each facial image's position in the video frame(s) in which it appears, and the number of times (e.g., frames, or collection of frames) or duration the facial image appears in the video. The index database 218 may provide searching capabilities to users that enable searching the videos for the appearance of an individual associated with a facial image identified in the index database. Furthermore, in an embodiment, pattern database 220 may be a database populated with reference or representative facial images of clusters that have been identified. Using the pattern database 220, facial image clustering module 206 can quickly search through all of the clusters available in the cluster database 216. If a facial image or a new cluster closely matches a representative facial image present in the index database 218, digital media processor 112 may merge the new cluster with the cluster referenced by the representative facial image.

### Facial Image Processing in a Digital Media Processor

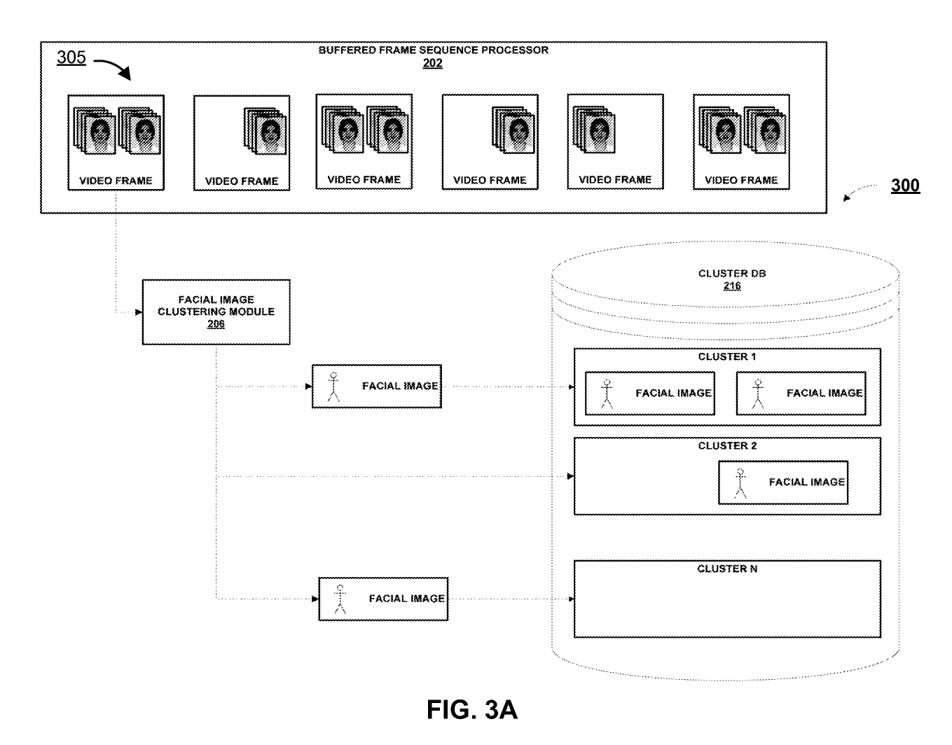

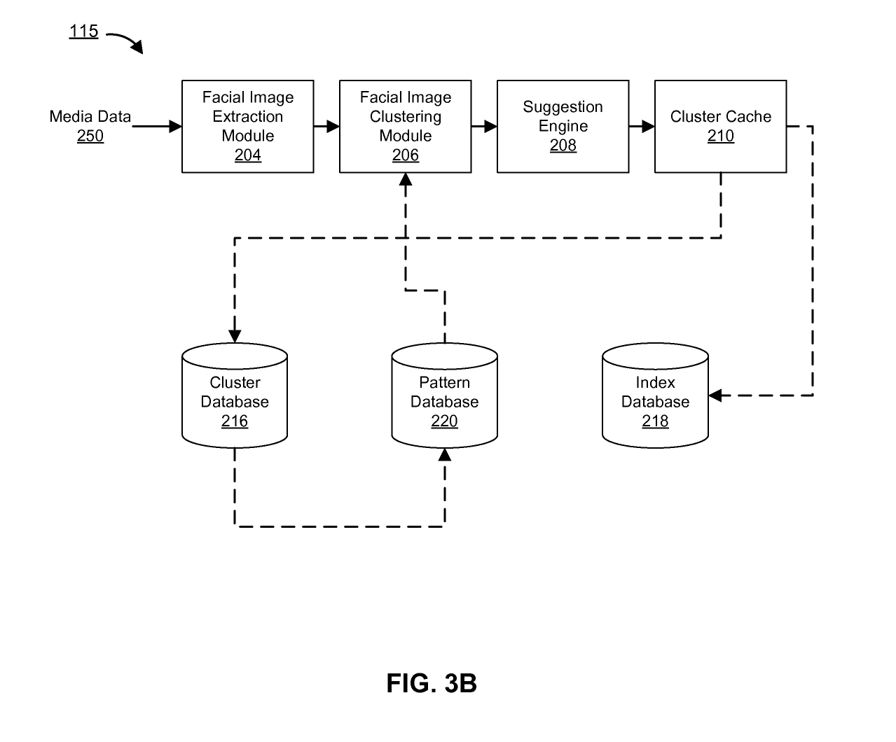

FIG. 3A is a block diagram of an environment within which a facial clustering module is implemented, in accordance with an embodiment. The components shown include buffered frame sequence processor 202, facial image clustering module 206, cluster database 216, and example clusters 1 through N. Other embodiments of the facial clustering module environment 300 may include more or less components than shown in FIG. 3A. The environment 300 illustrates how the buffered frame sequence processor 202 contains video clips of varying lengths that include a number of video frames 305 prior to processing. For example, facial image extraction module 204 identifies six frames 305, each including at least one facials image. The facial images may be extracted from the frames by the facial image extraction module 204. In turn, the clustering module 206 process the facial images in each of these groups of video frames 305 from the video clips to determine a corresponding cluster(s) assignment for each facial image (and/or frame containing the facial image therein). For facial images that belong to identified people, the facial image is grouped with the same cluster in cluster database 216. For facial images that belong to unidentified people, facial image clustering module 206 may create a new cluster (e.g., cluster N).

In some embodiments, multiple people may be present within video clip frames 305. In this scenario, facial image clustering module 206 may duplicate the frame and cluster each frame with a different cluster. For example, if President Obama and Governor Romney appear in a set of video frames together, facial image clustering module 206 may group that set video frames under two different clusters. One cluster may have frames with President Obama's facial image while the other cluster may have frames with Governor Romney's facial image.

FIG. 3B is a block diagram showing data flow and correlations between various components of a media processing system for implementing clustering, in accordance with an embodiment. Media data 250 may be digital content that has been initially processed by the buffered frame sequence processor 202 and has been split into groups of frames. Alternatively, the facial image extraction module 204 may receive the media data 250 (e.g., a video stream containing frames) directly. These frames are passed into a facial image extraction module 204 that filters the frames and determines which frames contain facial images. The facial images appearing in these frames may also be normalized before being passed into a facial image clustering module 206 that clusters a given facial image with other facial images that the module identifies as a close match. The facial image clustering module 206 also receives data from pattern database 220 and begins to compare facial images in the formed clusters with template facial images from pattern database 220.

For each cluster formed or merged by facial image clustering module 206, suggestion engine 208 may label the new clusters based on information associated with template facial images from the pattern database 220 (e.g., in the case of a recognition), contextual data extracted from the video feed by facial image extraction module 204, or an operator input. The clusters may be stored temporarily in cluster cache 210 throughout processing of the received media data 250 as the individuals identified therein may appear frequently. The facial images in the clusters are stored in cluster database 216 while indexing information (e.g., time intervals that certain faces appear in a video, specific videos that certain faces appear in, and so forth) are stored in index database 218. Commonly appearing facial images or representative facial images of each cluster is also forwarded from the cluster database 216 and stored in pattern database 220 as a reference for use when facial image clustering module 206 is processing new video frames. The information in index database 218 can be searched for by digital media search processor 114.

### Facial Image Extraction Module Components

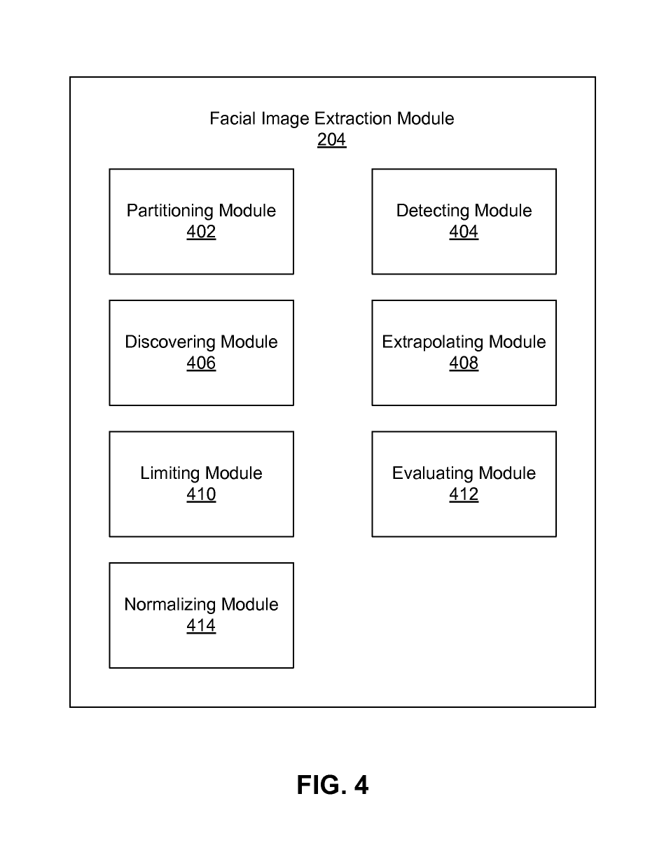

FIG. 4 is a block diagram showing various components of a facial image extraction module 204, in accordance with an embodiment. As shown in FIG. 4, the facial image extraction module 204 includes partitioning module 402, detecting module 404, discovering module 406, extrapolating module 408, limiting module 410, evaluating module 412, and normalizing module 414. Other embodiments of facial image extraction module 204 may contain more or less modules than what is illustrated in FIG. 4.

Partitioning module 402, in an embodiment, processes buffered facial image frames from buffered frame sequence processor 202 by separating the frames out into smaller sized groups. For example, if a video containing 1000 frames is inputted into the buffer frame sequence processor 202, the processor may separate the frames into 10 groups of 100 frames for buffering purposes until the frame sets can be processed by other modules. Partitioning module 402 may separate each group of 100 frames further into groups of 10 or 15 frames each. Furthermore, partitioning module 402 may also separate frames by other factors, such as change of source, change of video resolution, scene change, logical breaks in programming and so forth. By identifying logical breaks between sets of frames, partitioning module 402 prepares the frame sets for detection module 404 to more efficiently detect facial images in sets of frames. Separating the frames allow more processing to be done in parallel as well as to reduce the workload for each set of frames to be processed by later modules.

Partitioned frame sets may then be transferred to detecting module 404 for further processing. Detecting module 404 may analyze the frames in each set to determine whether a facial image is present in each frame. In an embodiment, detecting module 404 may sample frames in a set in order to avoid analyzing each frame individually. For example, detecting module 404 may quickly process the first frame in a set partitioned by scene changes to determine whether a face appears in the scene. In an embodiment, detecting module 404 may analyze the first and last frames of a set of frames (e.g., between scene changes) for facial images. These frames are thus temporally proximate to each other. Frames that are temporally proximate are within a predetermined number of frames from each other. Analysis of intermediate frames may be performed only in areas close to where facial images are found in the first and last frames to identify facial images. The set of facial images identified are spanned facial images.

Facial images detected may exist in non-contiguous frames. In this scenario, extrapolating module 408 may be used to extrapolate facial locations across multiple frames positioned between frames containing a detected facial image without directly processing each frame. Extrapolating provides an approximation of facial image positions in the intermediary frames and thus regions likely to contain the same facial image. Regions unlikely to contain a facial image may be omitted from scans, thus reducing the computation load on the processor.

Limiting module 410 may be used in an embodiment to reduce the total necessary area that needs to be scanned for facial images. Limiting module 410 may crop the video frame or otherwise limit detection of facial images to the region identified by the extrapolating module 408. For example, President Obama's face may appear centered in a news video clip. Once extrapolating module 408 has identified a rectangular region near the center of the video frame containing President Obama's face, limiting module 410 may restrict detecting module 404 from searching outside of the identified rectangular region for facial images. In other embodiments, limiting module 410 may still allow detecting module 404 to search outside of the identified region for facial images if detecting module 404 is unable to find facial images on a first scan.

Detecting module 404 may detect facial images using various methods. In an embodiment, detecting module 404 may detect eyes that appear in frames. Eyes may both indicate whether a facial image appears in each frame as well as the facial image position according to eye pupil centers. Evaluating module 412 may be used to determine the quality of the possible facial images, in accordance with an embodiment. For example, evaluating module 412 may scan each facial image and determine if the distance between the eyes of a facial image appearing in the frame is greater than a predetermined threshold distance. A distance between eyes that is below a certain threshold makes identifying the face unlikely. Thus, frames or regions including faces having a distance between eyes of less than a threshold number may be omitted from further processing. Evaluating module 412 may also scan for certain qualities in a frame that may make later facial normalization processes difficult, such as extremes in brightness levels, odd facial positioning, unreasonable color differences and so forth. These qualities may cause the frame to also be omitted from further processing.

Because facial images may not be oriented in a consistent way throughout the different frames, normalizing module 414 modifies the facial images so that they are oriented in a similar position to aid in facial image comparisons with template images and with other facial images. Normalization may involve using eye position, as well as other facial features such as nose and mouth, to determine how to properly shift regions of a facial image to orient the facial image in a desired position. For example, normalizing module 414 may detect that a person in an image is facing upwards. By using the relative positioning of several facial features, normalizing module 414 can digitally shift the face and extrapolate a forward positioned face. In other embodiments, normalizing module 414 may shift the face so that it is facing the side or in another position.

In an embodiment, discovering module 406 may also be analyzing the video frames containing detected facial images for the presence of textual content. The textual content may be helpful in identifying the person associated with the detected facial images. Accordingly, frames including textual content are queued for processing by an optical character recognition (OCR) processor to convert the textual content into digital text. For example, textual content may be present in video feeds as part of subtitles or captions. Detecting module 404 scanning through video frames may detect facial images that appear in certain frames. Discovering module 404 may then queue those frames for additional processing through an OCR processor (not shown). The OCR processor may detect the subtitles on each frame and scan them to produce keywords that may contain the identity of the people appearing in the images.

### Facial Image Extraction and Initial Clustering Data Flow

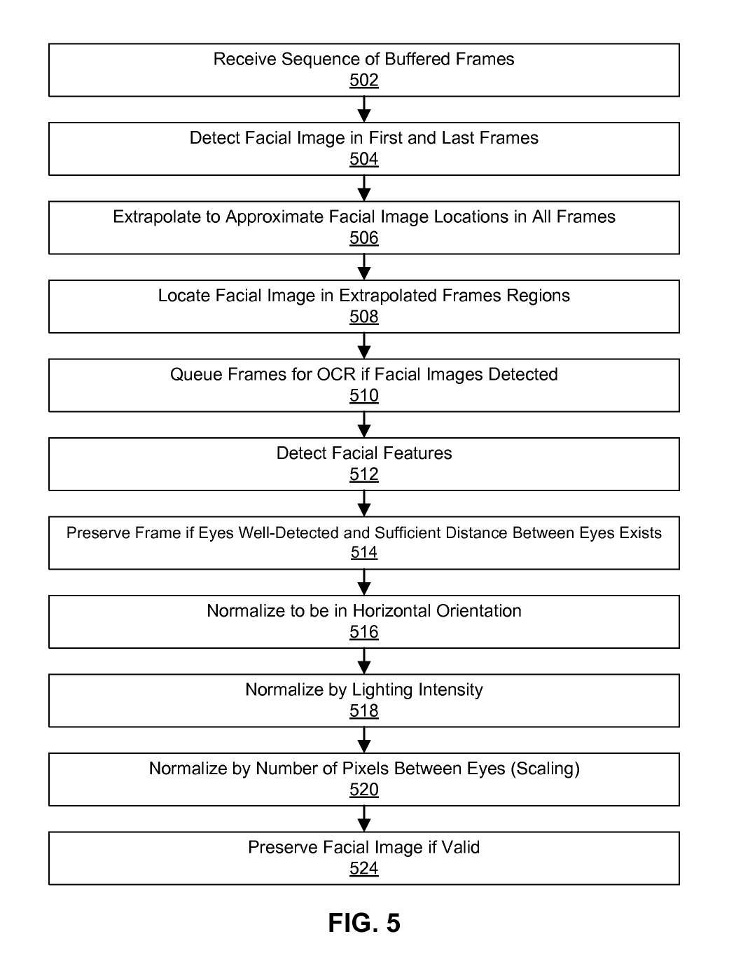

FIG. 5 is a flow chart of a method for video processing involving facial image extraction and initial cluster, in accordance with an embodiment. In turn, the facial image clustering module 206 may use the extracted facial image output to generate image clusters.

Digital media, such as video, are received by a buffered frame sequence processor 202 in a digital media processor 112, which may separate the video into buffered frames. The digital media processor 112 then receives 502 the sequence of buffered frames, which may be further partitioned by partitioning module 402, and uses detecting module 404 to detect 504 facial images in the first and last frames of each set of buffered frames. The facial images in the first and last frames may be temporally proximate. Facial image extraction module 204 is thus able to determine sets of frames that may have facial images appear. Frame sets that have facial images appear in either the first or last frames, or both the first and last frames may be furthered processed by an extrapolating module 408. The extrapolating module 408 extrapolates 506 facial images to determine approximate locations in all frames where facial images are likely to appear.

Detecting module 404 may scan the approximate facial image regions to locate 508 facial images. Frames with facial images may also be queued 510 for an OCR by discovering module 406. Textual data extracted by discovering module 406 and an OCR may provide the identity of faces that appear in those frames. Detecting module 404, in coordination with limiting module 410 and evaluating module 412, may detect 512 certain facial features (e.g., eyes, nose, mouth, ears, and so forth) as facial “landmarks.” Because facial images should be of a certain size and quality before facial recognition can be carried out with reasonable computing resources, each facial image is analyzed by evaluating module 412. Determining thresholds may differ between different embodiments, but in an embodiment, eyes that are well-detected and have sufficient distance between eyes may be preserved 514 for further processing. Frames that do not meet the thresholds may be omitted.

To efficiently and accurately compare facial images from video frames with reference/template facial images from a pattern database 220, each extracted facial image should be normalized. In an embodiment, normalizing module 414 processes each facial image so that the face is normalized 516 in a horizontal orientation, normalized 518 for lighting intensity, and normalized 520 for scaling (e.g., through normalizing the number of pixels between the eyes). In other embodiments, a different combination of normalizing procedures using steps both listed and not listed in this embodiment may be used to normalize facial images for clustering. It should be noted that even though the procedure described herein relates to detecting and normalizing a human face, a person skilled in the art will understand that similar normalization procedures may be utilized to normalize images of any other object categories including, but not limited to, cars, buildings, animals, helicopters and so forth. Furthermore, it should be noted that the detection techniques described herein may also be utilized to detect other categories of objects. Images determined as valid, or as providing sufficient information for a facial image to be identified, by evaluating module 412 may then be preserved 524 for clustering purposes. Other embodiments may determine video frame validity to preserve 524 for clustering through other means, such as identifying frames proximate to other frames that contain identifiable facial images or containing contextual information relevant to other frames that have identifiable facial images.

### Facial Image Clustering

Facial image clustering involves taking facial images of people appearing in different frames of a video and grouping them into a “cluster.” Each cluster contains facial images of individuals that have same common trait. For example, a cluster may contain facial images of the same person, or it may contain facial images of people that have specific facial features in common. By forming clusters of similar facial images, digital media processor 112 is able to more quickly and effectively identify individuals that appear in videos. Grouping like facial images together also reduces the computing resources that have to be devoted to comparing, matching, and identifying facial images by reducing the need to perform intensive computations on every facial image in every video frame.

In an embodiment, facial image clustering occurs as facial image clustering module 206 is sorting through the sets of video frames from a facial image extraction module. An initial method of separating and partitioning the sets of video frames is by analyzing the frames for changes in scenes in facial image extraction module 204. Once facial images are extracted from these frames by the facial image extraction module 204, facial image clustering module 206 can perform additional analysis on the sets of facial images to cluster images. Facial image movements may also be identified and tracked throughout the scene. Face detection and tracking may include labeling each face with a unique track identifier. By tracking a facial image as it moves around the field of view within a set of frames, facial image clustering module 206 may determine that the facial images appearing in the different frames belong to the same person and may cluster the frames together.

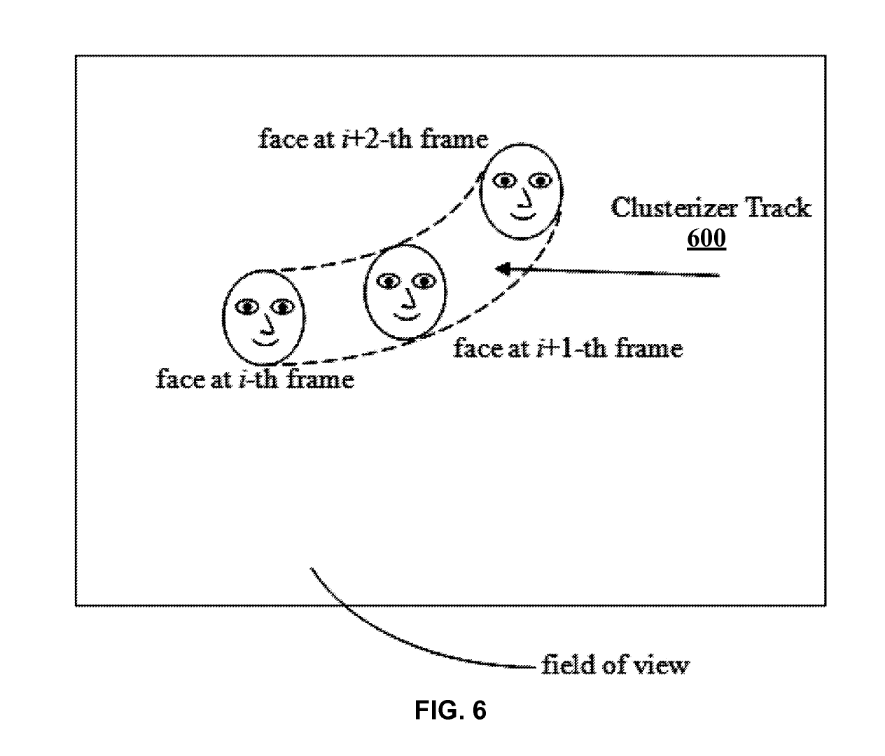

FIG. 6 illustrates a clusterizer track, in accordance with an embodiment. As facial image clustering module 206 identifies and tracks facial images in different frames through time, it may determine a clusterizer track 600. A clusterizer track 600 shows the path that a facial image moves in through a time period spanned by the video frames. For example, a face appears in the 10^{th} frame of a video clip. On the 11^{th} frame, the face may have moved slightly upwards and rightwards. On the 12^{th} frame, the face may have moved slightly farther in the same direction. If the distances between the facial images in each of the frames do not exceed a certain threshold, then facial image clustering module 206 may determine that the individual facial images belong to the same individual and may group them into the same cluster. However, if the distances between facial images exceed the threshold, then facial image clustering module 206 may cluster the images into separate clusters.

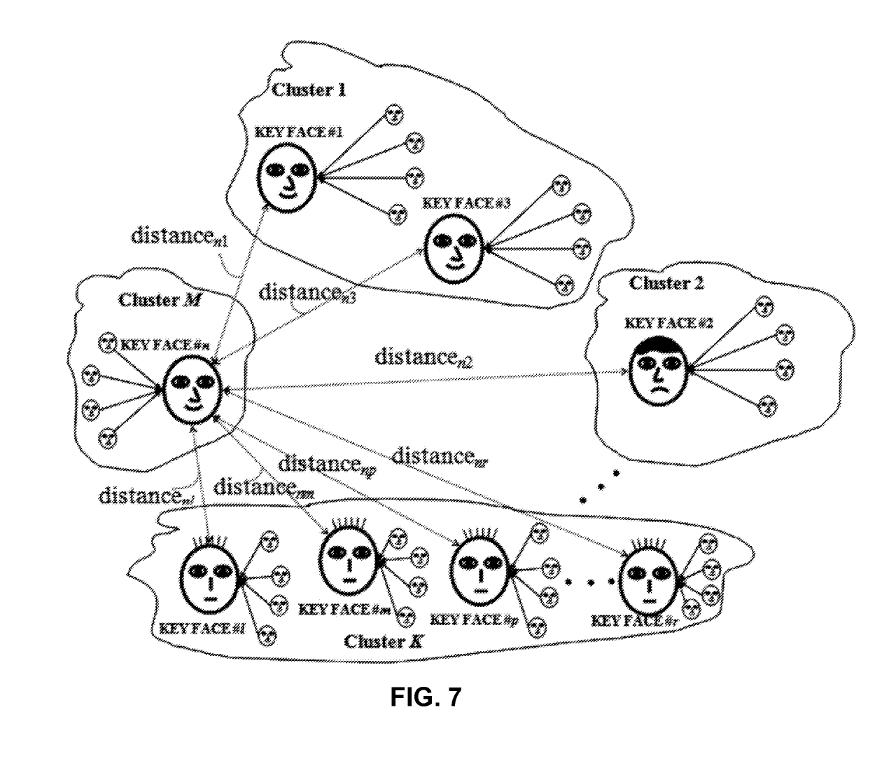

As new clusters are formed, these clusters are compared with previously formed clusters. FIG. 7 illustrates an example of merging clusters, in accordance with an embodiment. As shown, each cluster includes one or more “key face” or representative facial image that best represent the facial images in the cluster. Key faces from one cluster may be compared with key faces from other clusters to determine distances between the clusters. As new clusters are created, an unknown key face from the new cluster may be compared with key faces from other clusters. For example, a key face #n is associated with cluster M. Key face #n is compared to key face #1, key face #2, key face #3, key face #1, key face #m, key face #p, key face #r, and any other key faces that exist. Distances between key face #n and each of the other faces are calculated. These distances are represented in FIG. 7 by distance_{ab}, where subscript a denotes the source key face and subscript b denotes the compared key face. Facial image clustering module 206 compares each distance to a threshold value and determines whether two clusters should be merged, should be kept separate, or more calculations should be performed to generate a more certain result. Clusters that are merged may have facial images of the same person while clusters that are separate may have facial images of different people.

Multiple key faces may be selected to represent each cluster due to various factors, which may include different orientations of the face, slight changes in the face over time, slight coloration differences and the like. Each key face adds significant additional information to the cluster for digital media processor 112 to have available for identifying unknown facial images. By identifying multiple images as key faces, digital media processor 112 increases the probability that an unknown image or cluster may be identified and associated with an individual. Each key face may also be associated with a set of sub-facial images that form a spanned face. Facial images that form the spanned face are additional images that may not add significant information to an existing key face, such as repetitive facial images or duplicate frames.

### Facial Image Clustering Module Components

In an embodiment of digital media processor 112, facial image clustering module 206 performs the computations related to clustering. As video frames from a buffer are sent into a facial image clustering module 206, each frame (or the facial image identified in the frame) is analyzed and grouped into a cluster containing facial images of the same person. Facial image clustering module 206 also compares these clusters with previously created clusters and merges clusters as necessary. In an embodiment, clusters may be identified according to the person that each contains. In other embodiments, clusters may be identified by some other common traits, which may include facial geometry, eye color, nose structure, hair style, skin color and so forth. Clusters formed by facial image clustering module 206 are stored in cluster database 216, with indexing information stored in index database 218.

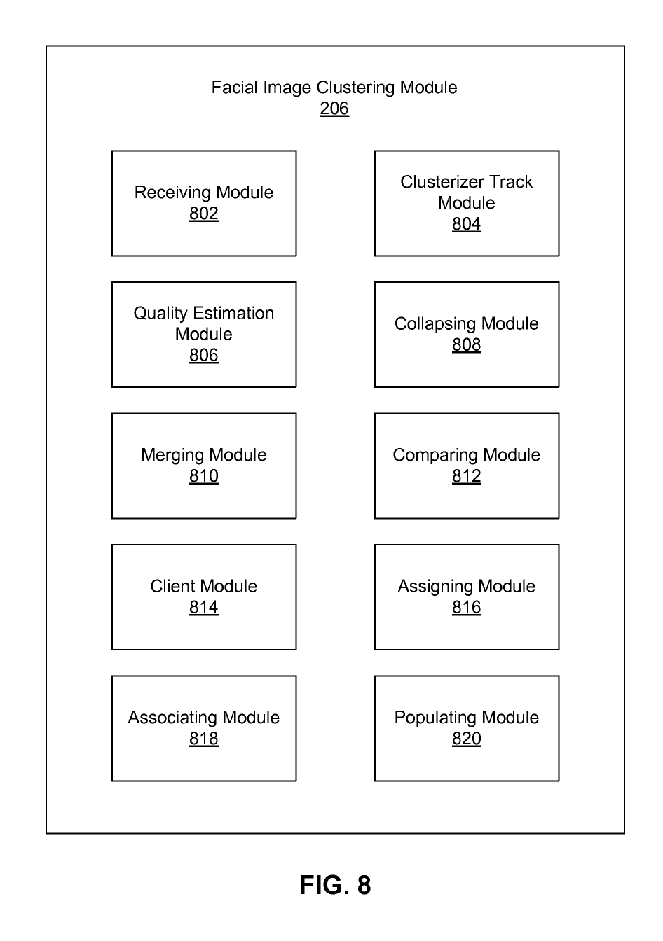

FIG. 8 is a block diagram showing various components of a facial image clustering module 206, in accordance with an embodiment. The facial image clustering module 206 includes a receiving module 802, clusterizer track module 804, quality estimation module 806, collapsing module 808, merging module 810, comparing module 812, client module 814, assigning module 816, associating module 818, and populating module 820. Other embodiments of a facial image clustering module 206 may include more or less modules than is represented in FIG. 8.

Images processed by a facial image extraction module 204 are received by facial image clustering module 206 using receiving module 802. Receiving module 802 prepares facial image frames by temporarily storing a certain number of frames before releasing the frames to a clusterizer track module 804, which will identify clusterizer tracks 600.

A clusterizer track module 804 receives sets of facial images in buffers from a receiving module 802, in accordance with an embodiment. The clusterizer track module 804 selects a representative facial image frame in each buffered set and facial images from frames surrounding it. Clusterizer track module 804 then calculates the distances between the representative facial image and the facial image in other proximate frames. If the distances between the facial images in the frames fall within a specified threshold, then clusterizer track module 804 may determine that a clusterizer track 600 exists. A clusterizer track 600 outlines the path or region that clusterizer track module 804 may expect to find facial images in a series of video frames. Clusterizer track module 804 may form clusters from facial images along the same clusterizer track 600. The formation of clusterizer tracks 600 was illustrated earlier in FIG. 6.

In an embodiment, facial images are analyzed for quality by a quality estimation module 806. Facial images from clusterizer track module 804 may be referred to as “crude faces” as they may consist of facial images of varying quality. Quality estimation module 806 performs various procedures, which may include a Fast-Fourier-Transformation (FFT), to determine values for image quality. In an embodiment using FFT, high-pass (HP) and low-pass (LP) components of an image can be calculated. A higher HP-LP ratio indicates that an image contains more sharp edges and is thus not blurred. Each “crude face” is compared against a benchmark quality value to determine whether the image is stored or removed.

Collapsing module 808 receives sets of “quality images” processed by a quality estimation module 806 and determines a key face among the set, in accordance with an embodiment. The key face is thus a representative face for the cluster, allowing collapsing module 808 to “collapse” or reduce the amount of data considered as critical to the cluster. In an embodiment, only the key face is stored and the rest of the faces are considered as spanned face. By representing an entire cluster with a key face, digital media processor 112 can reduce the number of comparisons and thus the computing resources necessary to identify facial images in a video.

Clusters that contain facial images that are similar may be considered for merging. In an embodiment, merging module 810 compares key faces between the newly formed clusters. If the distances between the key faces fall within a certain threshold, then merging module 810 may combine the clusters containing the compared key faces. However, merging is based on a relatively slow, but accurate, face comparison between the key face of two or more clusters. For example, merging clusters consolidates facial images of the same person so that subsequent facial image identification and comparisons can be performed with few prior clusters needing to be compared. The process merging clusters was illustrated earlier in FIG. 7.

Once clusters are formed and the merging of clusters is completed, comparing module 812 in an embodiment compares the facial images in the cluster to reference facial images from pattern database 220. To minimize computing time, a fast and rough comparison may be performed by comparing module 812 to identify a set of likely reference facial images and exclude unlikely reference facial images before performing a slower, fine-pass comparison. In an embodiment, comparing module 812 automatically performs the comparisons based on distances between a cluster key face and a reference facial image from a pattern database 220 and determines acceptable suggestions as to the identity of the facial images in a cluster.

In the scenario that there are no reference facial images from pattern database 220 that adequately match the key face of a cluster, then facial image clustering module 206 may, in an embodiment, use client module 814 to prompt a user or operator for a suggestion. For example, an operator may be provided with an unknown key face along with other extracted contextual information about the key face and asked to identify the person. After the operator visually identifies the facial image, client module 814 can update pattern database 220 so that the operator is not likely to be prompted in the future for manual identifications of facial images belonging to the same person.

In an embodiment, when a cluster is identified, assigning module 816 may attach identifying metadata or other information to the cluster. Associating module 818 may also reference index information stored in index database 218 and associate new cluster data identifiers with the index information stored in index data base 218. For example, associating module 818 may store metadata relating to, but not limited to, a person's identity, location in the video stream, time of appearance, and spatial location in the frames. In an embodiment, the processed cluster data may then be saved to cluster database 216 by populating module 820.

### Data Flow of Facial Image Clustering

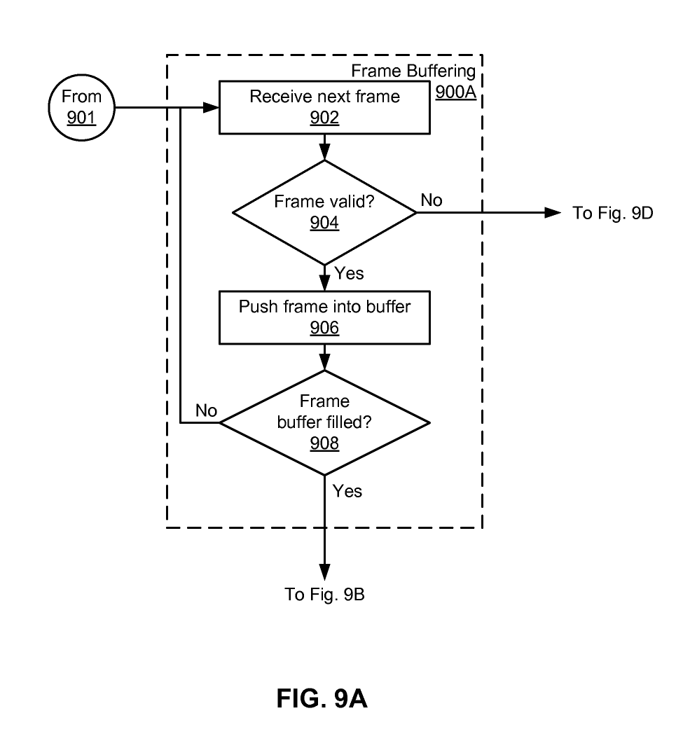

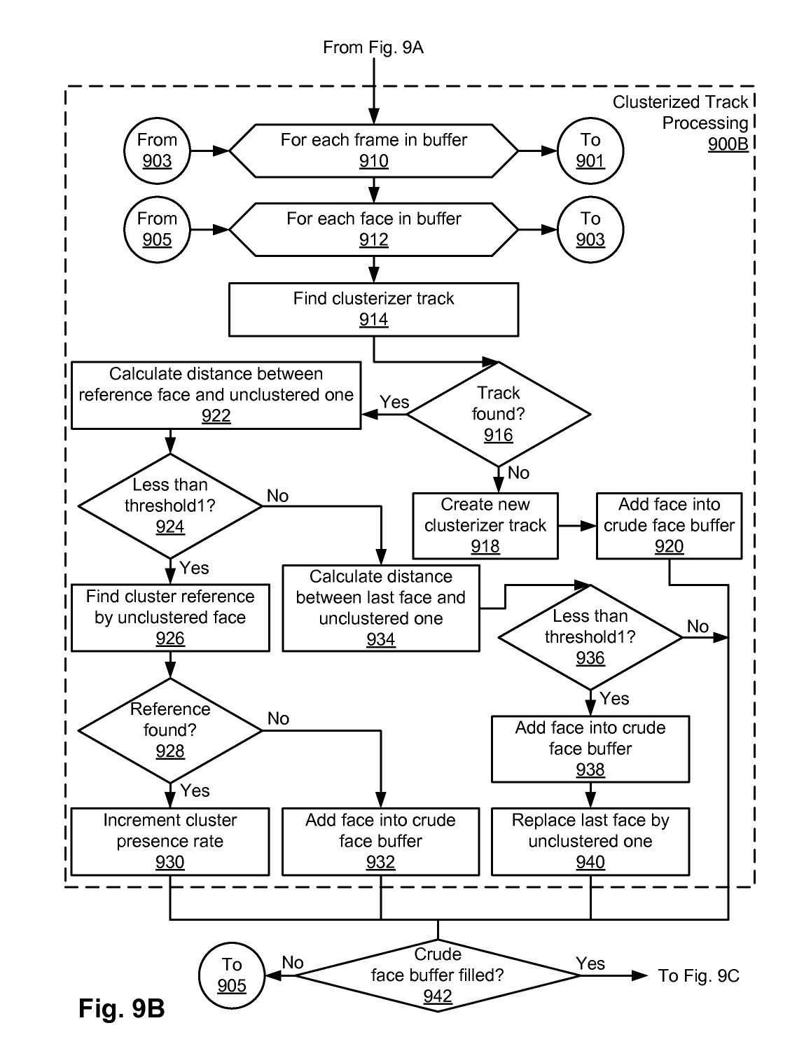

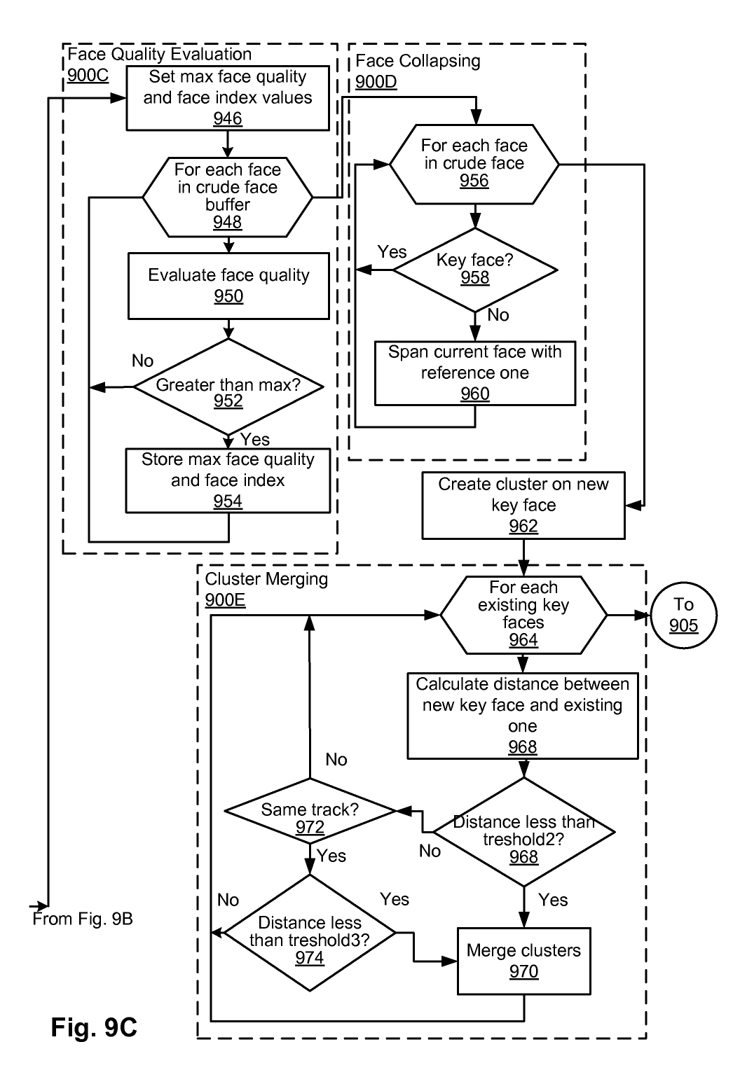

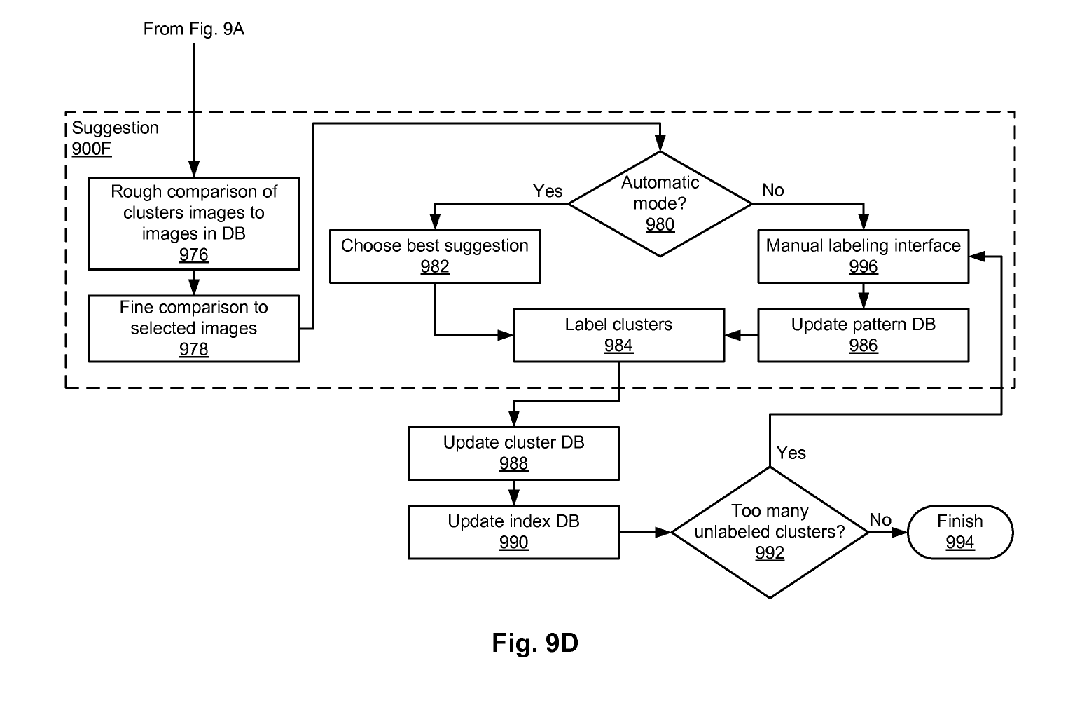

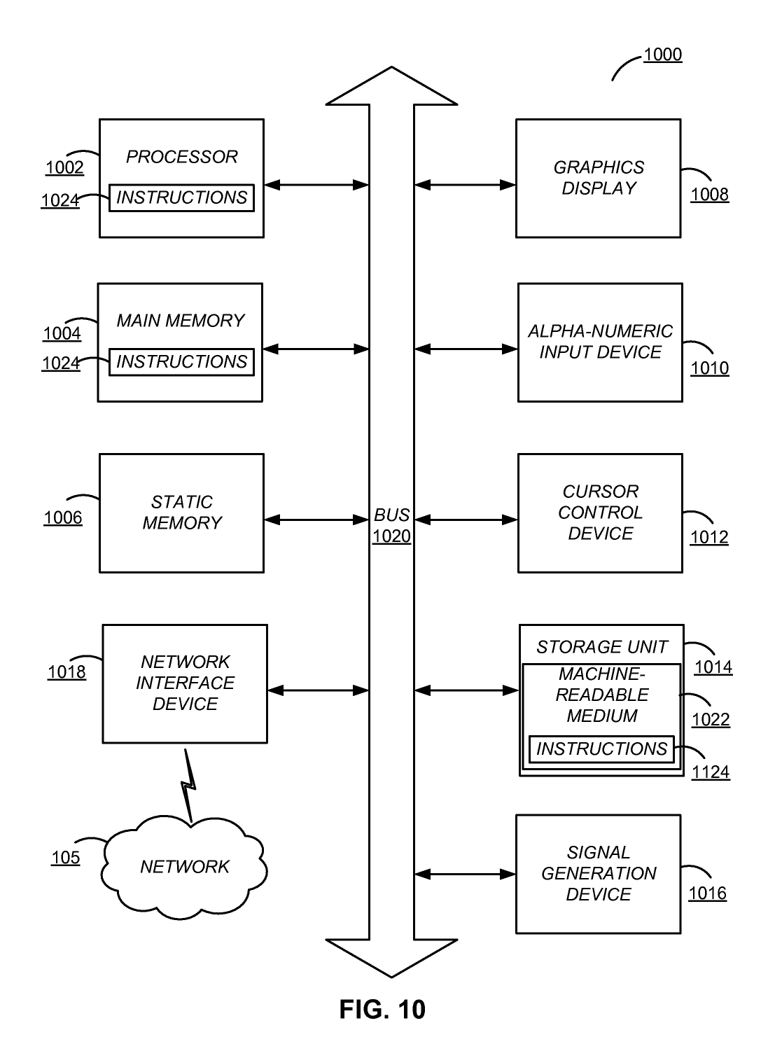

FIGS. 9A, 9B, 9C, and 9D illustrate flow diagrams that show a method for clustering facial images, in accordance with an example embodiment. The method may be performed by processing logic that may comprise hardware (e.g., dedicated logic, programmable logic, microcode, etc.), computer program code or modules executed by one or more processors to perform the steps illustrated herein (for example, on a general purpose computer system or computer server system illustrated in FIG. 10), or a combination of both. In an example embodiment, the processing logic resides at the digital media processor 112. The method may be performed by the various modules of a facial image clustering module 206. To more clearly illustrate the method for clustering facial images, FIGS. 9A, 9B, 9C, and 9D each describe different components.

The method for clusterizing images commences with frame buffering 900A. During frame buffering 900A, video frames are received 902 and checked for validity 904. Valid frames are pushed 906 into a frame buffer for temporary storage. The purpose of the buffer is to collect some quantity of frames to process quickly. The process of receiving and checking the frames is repeated until the frame buffer becomes full 908 of the last frame of the video is received. At this point, the facial image clustering module 206 proceeds onto the clusterized track processing 900B process, which is illustrated in FIG. 9B.

The embodiment of clusterized track processing 900B process shown in FIG. 9B may be performed by clusterizer track module 804. Each facial image from a buffer is analyzed to determine if a clusterizer track exists and if the facial image can be related to an existing reference facial image. Through identifying tracks and comparing to prior facial images, facial image clustering module 206 may decide whether an incoming facial image is inserted into a crude face buffer, incremented into a presence rate, or discarded. A crude face buffer contains unidentified facial images to be further optimized and analyzed at a later point in the process.

In a clusterized track processing 900B process, each frame in a video buffer contains facial images that are assigned a unique track identifier, which is used to find 914 a clusterizer track. At operation 916, for each facial image, if a track is not found, then an incoming facial image (unclustered facial image) is used to establish 918 a new clusterizer track. The unclustered facial image is then added 920 to a crude face buffer before the process repeats again with the next frame in the video feed.

In the scenario that a track is found at operation 916, then the unclustered facial images are compared to a reference facial image. The clusterizer track module 804 calculates 922 the distance between the unclustered facial image and a reference face. This process may be performed using an algorithm or an object used to evaluate the similarity of objects. In an embodiment, the distance between the unclustered facial image and a representative facial image is represented by a coefficient of similarity. A higher coefficient value may indicate a greater likelihood that both faces belong to the same cluster. In other embodiments, a discrete-cosine-transformation (DCT) for feature extraction and L1-norm for distance (similarity) calculation, or motion field and affine transformation may be used. The clusterizer track module 804 should perform comparisons and calculations quickly and with an adequate degree of accuracy so that the facial image verifications can proceed smoothly.

At operation 924, if the unclustered facial image and the reference image are found to be sufficiently similar (e.g., below threshold 1), then the unclustered facial image may be matched to the reference facial image. At operation 928, if a reference to a cluster can then be found 926 for the unclustered facial image (e.g., through association with the reference facial image or through contextual information extracted from the video feed), then the cluster presence rate is thus incremented 930. A cluster presence rate indicates the amount of frames where the object in a cluster has appeared and subsequently been clustered. In an embodiment, the unclustered facial image can then be dropped in part because the unclustered face is too similar to the reference facial image to provide additional recognition information. At operation 928, if no references could be found, then the unclustered facial image is inserted 932 into a crude face buffer for later analysis.

At operation 924, if the unclustered facial image and the reference image are found to be sufficiently distinct (e.g., above threshold 1), then facial image clustering module 206 may compare the unclustered facial image with the current last facial image (e.g., the previous unclustered facial image from the video frame buffer that was compared and analyzed) and calculate 934 a distance. At operation 936, if the distance is above a certain threshold (e.g., threshold 1), then the unclustered facial image is added 938 to the crude face buffer and replaces 940 the current last facial image. At operation 936, if the distance is below a certain threshold (e.g., threshold 1), then the unclustered facial image may be assumed to be too similar to the last facial image compared. The unclustered facial image thus offers no additional recognition information and may be discarded.

Once the clusterized track processing 900B finishes or the crude face buffer 942 is filled, the process continues onto a face quality evaluation 900C, which is shown in FIG. 9C. During a face quality evaluation 900C, each facial image in the crude faces buffer is evaluated 950 for quality. If the facial image quality is sufficient for spanning a reference face (forming a more complete model of a reference face) or may serve as a quality representative face, the face may be stored 954. In an embodiment, a Fast-Fourier-Transformation (FFT) may be used to determine high-pass (HP) and low-pass (LP) components of an image. The HP and LP components indicate the sharpness of the image; thus, a facial image with the maximum HP-LP ratio may be chosen for the sharpest quality. Quality value indicators may be compared to initial index values set 946 as a benchmark for facial quality.

Quality facial images are analyzed in the face collapsing 900D process to determine whether the face can become stored as a key face for an existing or a new cluster. An embodiment of face collapsing 900D is shown in FIG. 9C. Each cluster contains a reference to a key face and each key face contains a reference to a cluster. If an existing cluster belonging to a clusterizer track does not have a key face, then it can import a key face from the processed crude face buffer. That facial image thus becomes the representative face for the related sequence of faces in the crude face buffer. If a sequence already has a key face, then that key face and the unclustered facial image are compared to determine which one is more representative of the cluster's images. In one embodiment, only the key face is stored and the rest of the facial images are considered as spanned face. Storing facial images as part of a spanned face rather than as a key face reduces the amount of information needed to be stored. The new key face may then be used to create 962 a new cluster.

In some instances, it may be necessary to merge one or more clusters. For example, new clusters may represent individuals that already have existing clusters in cluster database 216. In an embodiment of cluster merging 900E, a facial image clustering module 206 may reduce the redundancy present in the database. A merging is based on relatively slow, but accurate, face comparison between the key faces of two clusters. An embodiment of cluster merging 900E is shown in FIG. 9C. In this embodiment, new key faces are compared to existing key faces. By comparing the calculated distances 968 between the two faces and whether they are from the same clusterizer track 972, facial image clustering module 206 may determine whether to merge 970 the clusters.

Once the process of creating and merging clusters is complete, facial image clustering module 206 may begin to identify the facial images in each cluster through the process of suggestion 900F. An embodiment of the suggestion 900F process is shown in FIG. 9D. To reduce the computational load on a processor and to hasten the comparison process, rough comparisons of cluster images may be compared 976 to image patterns present in pattern database 220. The rough comparison can quickly identify a set of possible reference facial images and exclude unlikely reference facial images before a slower, fine-pass identification 978 takes place. From this fine comparison, only one or very few reference facial images may be identified as being associated with the same person as the facial image in the cluster.

In most scenarios, facial image cluster module 206 may be able to automatically identify 982 and label 984 the clusters based in part on the distance calculated between the unidentified key face and a reference facial image during the fine comparison. In some embodiments, there may be a list containing a predetermined number of suggestions generated for every facial image. In other embodiments, there may be more than one suggestion method utilized based on different recognition technologies. For example, there may be several different algorithms performing recognition, each calculating distances between the key face in the new cluster and the reference facial images from existing clusters. The precision with which the facial image in existing clusters is identified may depend on the size of the pattern database 220.

However, there may be some scenarios where too many likely suggestions exist for facial image clustering module 206 to make an automated choice. In this case, an operator may be provided with the facial image for manual identification. For example, cluster database 216 may be empty and accordingly there will be no suggestions generated, or the confidence level of the available suggestions may be insufficient. Once an operator has identified the facial image, pattern database 220 may be updated 986, so that future related images do not require manual identification, and the cluster is labeled 984 appropriately.

Once the cluster is labeled with the correct identification, the cluster database 216 and index database 218 are updated 988, 990. New cluster images or updated cluster images are stored in cluster database 216 while new or updated references (e.g., links to key faces or associated facial images) are stored in index database 218. If too many unlabeled clusters exist 992 after the updating process, then manual identification may be performed to identify the clusters and update 986 the pattern database 220 accordingly.

### Example Representation of Computing Device Capable of Clustering Objects

FIG. 10 shows a diagrammatic representation of a machine in the example form of a computer system 1000, within which a set of instructions for causing the machine to perform any one or more of the methodologies discussed herein may be executed. In an example embodiment, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer, a tablet computer, a wearable computer, a personal digital assistant, a cellular or mobile telephone, a portable music player (e.g., a portable hard drive audio device such as an MP3 player), a web appliance, a gaming device, a network router, switch or bridge, or any machine capable of executing a set of instructions (sequential or otherwise) that specify actions to be taken by that machine. Furthermore, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004, and a static memory 1006, which communicate with each other via a bus 1020. The computer system 1000 may further include a graphics display unit 1008 (e.g., a liquid crystal display (LCD), organic light emitting diode (OLED), or a cathode ray tube (CRT)). The computer system 1000 also includes an alphanumeric input device 1010 (e.g., a keyboard), a cursor control device 1012 (e.g., a mouse), a drive unit 1014, a signal generation device 1016 (e.g., a speaker), and a network interface device 1018.

The storage unit 1014 includes a machine-readable medium 1022 on which is stored one or more sets of instructions and data structures (e.g., instructions 1024) embodying or utilized by any one or more of the methodologies or functions described herein. The instructions 1024 may also reside, completely or at least partially, within the main memory 1004 and/or within the processor 1002 during execution thereof by the computer system 1000. The main memory 1004 and the processor 1002 also constitute machine-readable media.

The instructions 1024 may further be transmitted or received over a network 105 via the network interface device 1018 utilizing any one of a number of well-known transfer protocols (e.g., Hyper Text Transfer Protocol (HTTP)).

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “machine-readable medium” shall accordingly be taken to include, but not be limited to, solid-state memories, optical and magnetic media, and carrier wave signals. Such media may also include, without limitation, hard disks, floppy disks, flash memory cards, subscriber identity module (SIM) cards, digital video disks, random access memory (RAMs), read only memory (ROMs), and the like.

The example embodiments described herein may be implemented in an operating environment comprising software installed on a computer, in hardware, or in a combination of software and hardware. Thus, a method and system of object recognition and database population for video indexing have been described. Although embodiments have been described with reference to specific example embodiments, it will be evident that various modifications and changes may be made to these example embodiments without departing from the broader spirit and scope of the present application. Accordingly, the specification and drawings are to be regarded in an illustrative rather than a restrictive sense.

### Additional Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms, for example, as illustrated in FIGS. 1, 2, 4, 8, and 10. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 1002, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms non-transitory data or media represented as physical or tangible (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise. Upon reading this disclosure, those of skill in the art will appreciate still additional alternative structural and functional designs for a system and a process for clustering and identifying facial images in media through the disclosed principles herein. Thus, while particular embodiments and applications have been illustrated and described, it is to be understood that the disclosed embodiments are not limited to the precise construction and components disclosed herein. Various modifications, changes and variations, which will be apparent to persons having skill in the art, may be made in the arrangement, operation and details of the method and apparatus disclosed herein without departing from the scope defined in the appended claims.

What is claimed is:

1. A computer-implemented method comprising:
receiving a video comprising a plurality of frames;
identifying a first frame and a second frame in the plurality of frames, the first frame and second frame temporally proximate, and each containing a facial image;
determining a clusterizer track identifying regions containing spanned facial images in frames between the first frame and the second frame, and in the first frame and the second frame;
selecting a key face from the spanned facial images associated with the clusterizer tracks, the key face representative of the spanned facial images of the track;
creating clusters represented by key faces and including spanned facial images; and
merging clusters based in part on distance comparisons between the key faces of the clusters.

2. The method of claim 1, wherein temporally proximate frames are within a predetermined number of frames from each other.

3. The method of claim 2, wherein the plurality of frames may be separated into temporally proximate sets, based in part on at least one of a predetermined frame count, duration, sampling rate, scene change, resolution change, source change, or a logical break in programming.

4. The method of claim 1, further comprising identifying facial images in one or more video frames, the identifying facial images further comprising:
identifying facial features in facial images;
normalizing facial images; and
preserving valid facial images.

5. The method of claim 4, wherein identified facial features include at least one of eyes, nose, mouth, and/or ears.

6. The method of claim 4, wherein normalizing is based in part on orientation, lighting, intensity, scaling, or a combination thereof.

7. The method of claim 1, wherein textual information may be extracted from frames containing facial images, the textual information providing details on the identity of the individual in the facial images.

8. The method of claim 1, wherein determining clusterizer tracks comprises:
detecting location of facial images in the first frame and last frame of each buffered set;
extrapolating approximate facial image locations in the buffered set; and
locating facial images in extrapolated frames regions.

9. The method of claim 1, wherein separate clusterizer tracks may be identified based in part on a distance calculated between facial images surpassing a threshold value, the distance comprising the difference between the facial images.

10. The method of claim 1, wherein each cluster is associated with an individual, the association comprising:
processing a rough comparison of cluster images to images in a template database;
processing fine comparison of selected images for more precise identification;
determining suggestions for identifying facial images in a cluster; and
labeling clusters, based in part on selected identification suggestions.

11. A digital media processor system embodied in a mobile computing device for clustering objects in video, the system comprising:
a buffered frame sequence processor configured to receive a video comprising a plurality of frames;
a facial image extraction module configured to identify a first frame and a second frame in the plurality of frames, the first frame and second frame temporally proximate, and each containing a facial image; and
a facial image clustering module configured to cluster similar facial images by being configured to:
determine a clusterizer track identifying regions containing spanned facial images in frames between the first frame and the second frame, and in the first frame and the second frame,
select a key face from the spanned facial images associated with the clusterizer tracks, the key face representative of the spanned facial images of the clusterizer track,
create clusters represented by key faces and including spanned facial images, and
merge clusters based in part on distance comparisons between the key faces of the clusters.

12. The system of claim 11, wherein the facial image extraction module is further configured to:
identify facial features in facial images;
normalize facial images; and
preserve valid facial images.

13. The system of claim 12, wherein the facial image extraction module is configured to normalize images based in part on orientation, lighting, intensity, scaling, or a combination thereof.

14. The system of claim 11, wherein the facial image extraction module is configured to extract textual information from frames containing facial images, the textual information providing details on the identity of the individual in the facial images.

15. The system of claim 11, wherein the facial image clustering module is further configured to:
detect a location of facial images in the first frame and the second frame;
extrapolate approximate facial image locations in the spanned images between the first frame and the second frame; and
locate facial images in extrapolated frames regions.

16. The system of claim 11, wherein the facial image clustering module is configured to identify separate clusterizer tracks based in part on a distance calculated between facial images surpassing a threshold value, the distance comprising the difference between the facial images.

17. The system of claim 11, wherein the system further comprises a suggestion module configured to associate each cluster with an individual by being further configured to:
process a rough comparison of cluster images to images in a template database;
process fine comparison of selected images for more precise identification;
determine suggestions for identifying facial images in a cluster; and
label clusters, based in part on selected identification suggestions.

18. A computer-implemented method comprising:
receiving media comprising a plurality of frames;
identifying a first frame and a second frame in the plurality of frames;
determining a clusterizer track identifying regions containing spanned images of objects in frames between the first frame and the second frame, and in the first frame and the second frame;
selecting a key face from the images associated with the clusterizer tracks, the key face representative of the images of the track;
creating clusters represented by key faces and including spanned images; and
merging clusters based in part on distance comparisons between the key faces of the clusters.

19. The computer-implemented method of claim 18, wherein the system for determining clusterizer tracks comprises:
detecting a location of facial images in the first frame and the second frame;
extrapolating approximate facial image locations in the spanned images between the first frame and the second frame; and
locating facial images in extrapolated frames regions.

20. The computer-implemented method of claim 18, wherein each cluster is associated with a type of object, the association comprising:
processing a rough comparison of cluster images to images in a template database;
processing fine comparison of selected images for more precise identification;
determining suggestions for identifying a type of object in a cluster; and
labeling clusters, based in part on selected identification suggestions.
